(19) United States
(12) Patent Application Publication
(10) Pub. No.: US 2006/0064854 A1
(43) Pub. Date: Mar. 30, 2006

(54) Hose clamp

(76) Inventor: Dian-Tai Chen, Taichung County (TW)

Correspondence Address: MORTON J. ROSENBERG, ESQ.;ROSENBERG, KLEIN & LEE, 3458 ELLICOTT CENTER DRIVE, SUITE 101, ELLICOTT CITY, MD, 21043, US

(21) Appl. No.: 10/949,309

(22) Filed: Sep. 27, 2004

(51) Int. Cl. F16L 33/08

(52) U.S. Cl. 24/274 R

(57) ABSTRACT

A hose clamp includes a binding belt, which has a flat head, a protruded portion adjacent to the flat head, a locating hole formed in the protruded portion, a through hole cut through the flat head, two bottom welding flanges at two sides of the through hole, and two bottom stop blocks in front of the through hole, and a screw holder attached to the top surface of the flat head to hold a screw for joining the ends of the binding belt and having two mounting plates respectively clamped on the bottom surface of the flat head and stopped between the stop blocks and the protruded portion and respectively welded to the welding flanges by spot welding, the mounting plates each having a positioning rod respectively engaged into the locating hole in the protruded portion.

### BACKGROUND OF THE INVENTION

1. Field of the Invention

The present invention relates to a hose clamp for fastening a hose to a pipe and more particularly, to a high-strength hose clamp, which is durable in use.

2. Description of the Related Art

FIGS. 1A and 1B show a hose clamp according to the prior art. According to this design, the hose clamp comprises a binding belt 11, and a screw holder 15 holding a screw 10. The binding belt 11 has a through hole 14 in the flat head thereof, two side notches 13 at two opposite lateral sides of the flat head, and four stop flanges 12 at two ends of each of the side notches 13. The screw holder 15 has two mounting plates 16 respectively fastened to the side notches 13 and stopped between the stop flanges 12 and locating rods 17 respectively extended from the mounting plates 16 at two sides and inserted through the through hole 14 from the back side toward the front side and then respectively clamped on the front surface of the flat head of the binding belt 11 in four corners around the through hole 14. This design of hose clamp is still not satisfactory in function because of the following drawbacks:

1. When the user rotating the screw 10 to fasten up the hose clamp, the torsional force produced from the rotary motion of the screw 10 may cause the locating rods 17 to deform and to disengage from the flat head of the binding belt 11 (see the imaginary line shown in FIG. 1C).

2. When rotating the screw 10 to fasten up the hose clamp, the torsional force thus produced may cause the mounting plates 16 to deform and to disengage from the side notches 13 of the flat head of the binding belt 11.

### SUMMARY OF THE INVENTION

The present invention has been accomplished under the circumstances in view. It is the main object of the present invention to provide hose clamp, which has a high strength and is durable in use.

To achieve this and other objects of the present invention, the hose clamp comprises a binding belt, the binding belt having a flat head, the flat head having a top surface and a bottom surface, a protruded portion adjacent to the flat head, a locating hole formed in the protruded portion, a through hole cut through the flat head, two welding flanges protruded from the bottom surface of the flat head at two opposite lateral sides of the through hole, and a plurality of stop blocks protruded from the bottom surface of the flat head in front of the through hole; and a screw holder fastened to the flat head of the binding belt to hold a screw for joining the ends of the binding belt, the screw holder comprising two mounting plates respectively clamped on the bottom surface of the flat head and stopped between the stop blocks and the protruded portion and respectively welded to the welding flanges by spot welding, the mounting plates each having a positioning rod respectively engaged into the locating hole in the protruded portion.

### BRIEF DESCRIPTION OF THE DRAWINGS

FIG. 1A is an exploded view of a hose clamp according to the prior art.

FIG. 1B is an assembly view in an enlarged scale of the hose clamp according to the prior art.

FIG. 1C is a schematic sectional view showing a breaking status of the hose clamp according to the prior art.

FIG. 2A is an exploded view of a hose clamp according to the present invention.

FIG. 2B is an assembly view of the hose clamp according to the present invention.

FIG. 3 is a schematic sectional view showing the fastening operation of the hose clamp according to the present invention.

FIG. 4 shows an alternate form of the hose clamp according to the present invention (the screw holder not shown).

FIG. 5 shows another alternate form of the hose clamp according to the present invention (the screw holder not shown).

FIG. 6 is an exploded view of still another alternate form of the hose clamp according to the present invention.

FIG. 7 is a perspective view of still another alternate form of the hose clamp according to the present invention.

FIG. 8 is a perspective view of still another alternate form of the hose clamp according to the present invention.

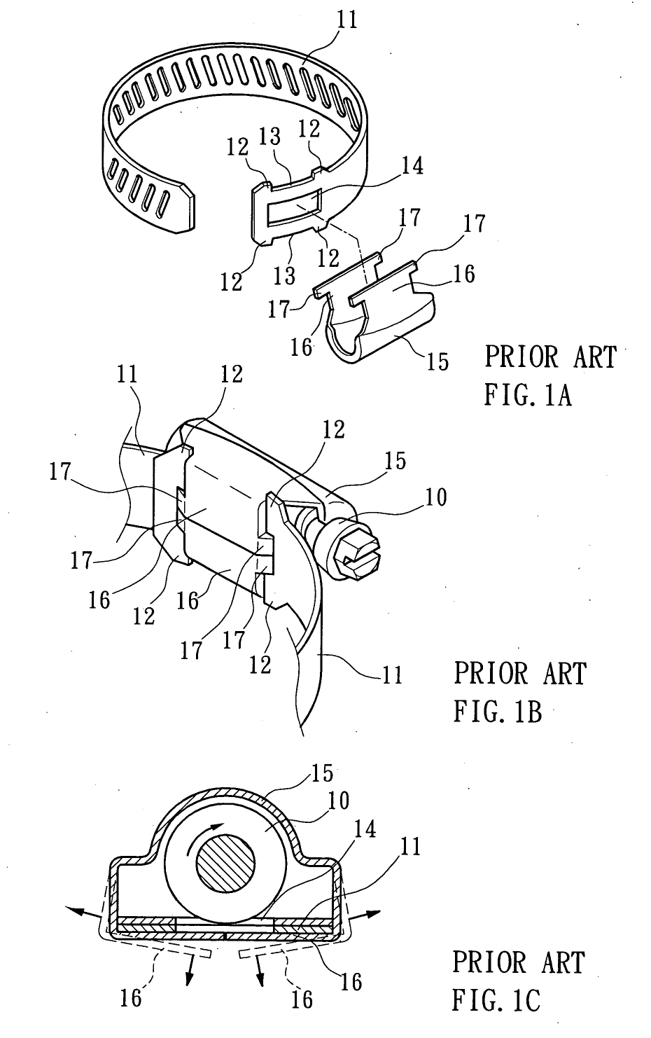

### DETAILED DESCRIPTION OF THE PREFERRED EMBODIMENT

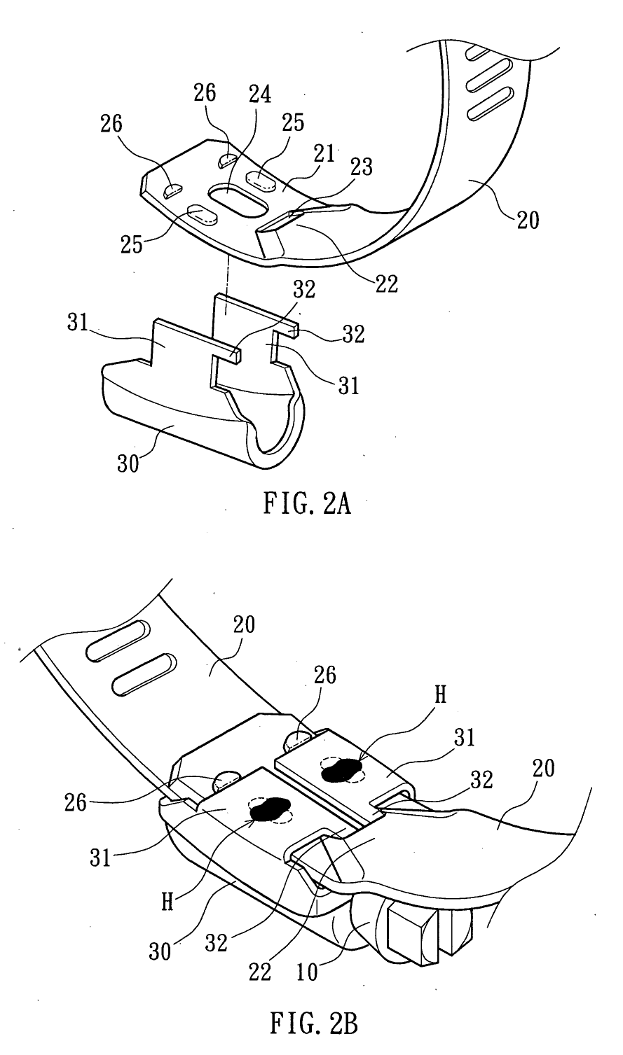

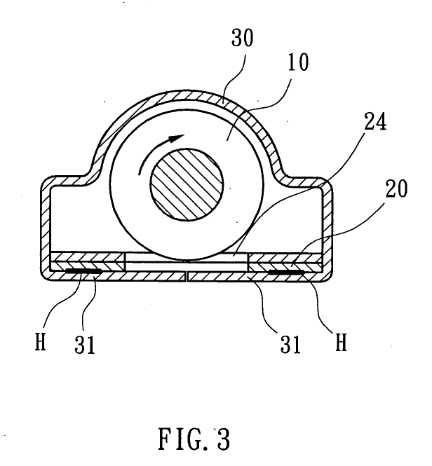

Referring to FIGS. 2A, 2B, and 3, a hose clamp in accordance with one embodiment of the present invention is shown comprised of a binding belt 20 and a screw holder 30 mounted with a screw 10.

The binding belt 20 has a flat head 21, a protruded portion 22 adjacent to the flat head 21, a locating hole 23 formed in the protruded portion 22, a through hole 24 cut through the top and bottom surfaces of the flat head 21, two welding flanges 25 protruded from the bottom surface of the flat head 21 at two opposite lateral sides of the through hole 24, and two stop blocks 26 protruded from the bottom surface of the flat head 21 in front of the through hole 24.

The screw holder 30 comprises two mounting plates 31 symmetrically disposed at two sides. Each mounting plate 31 has a positioning rod 32.

During installation, the screw holder 30 is attached to the top surface of the flat head 21 of the binding belt 20, and then the mounting plates 31 are respectively bent inwards and clamped on the bottom surface of the flat head 21 of the binding belt 20 and stopped between the stop blocks 26 and the protruded portion 22, keeping the positioning rods 32 engaged into the locating hole 23, and then mounting plates 31 are fixedly fastened to the welding flanges 25 by spot welding. H.

Because the mounting plates 31 of the screw holder 30 are stopped between the stop blocks 26 and the protruded portion 22 and because the positioning rods 32 of the mounting plates 31 are respectively engaged into the locating hole 23 of the binding belt 20, rotating the screw 10 to fasten up the binding belt 20 does not cause the screw holder 30 to break or to disconnect from the flat head 21. Further, because the mounting plates 31 are respectively welded to the welding flanges 25, the screw holder 30 is maintained firmly secured to the flat head 21 of the binding belt 20.

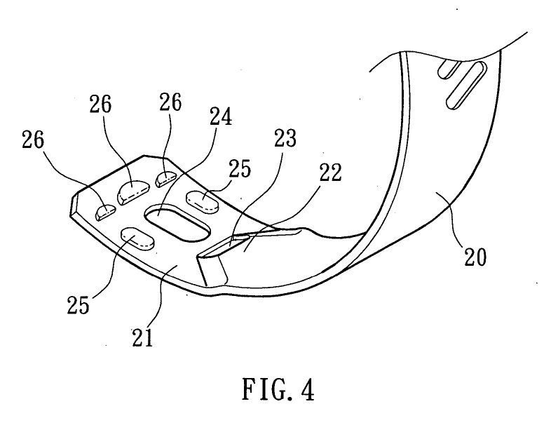

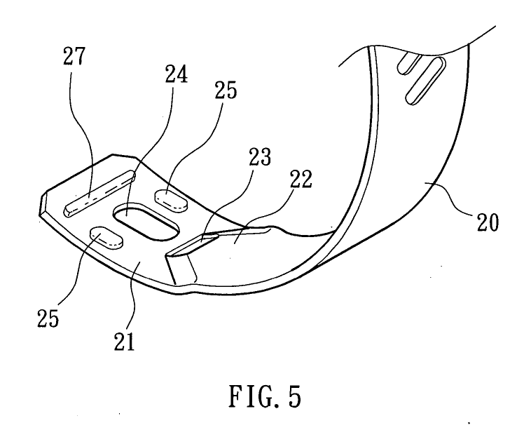

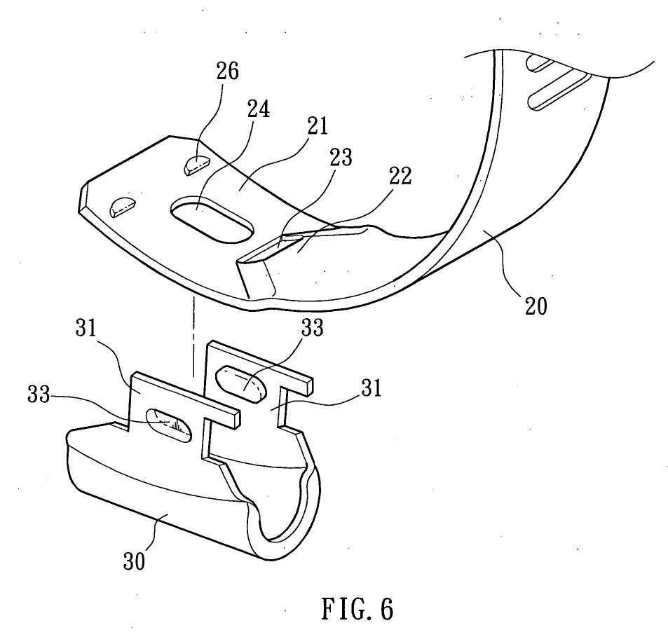

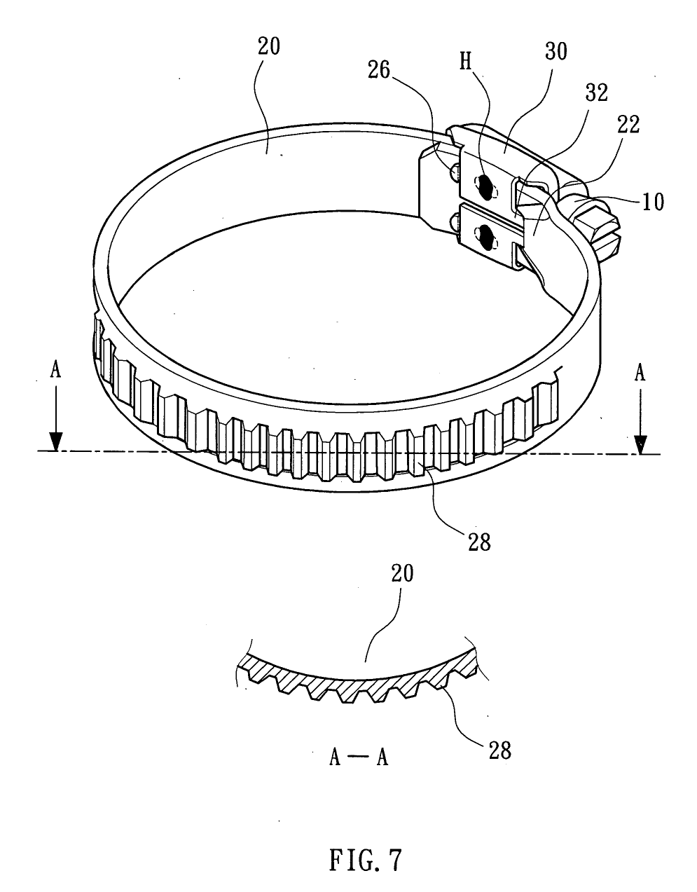

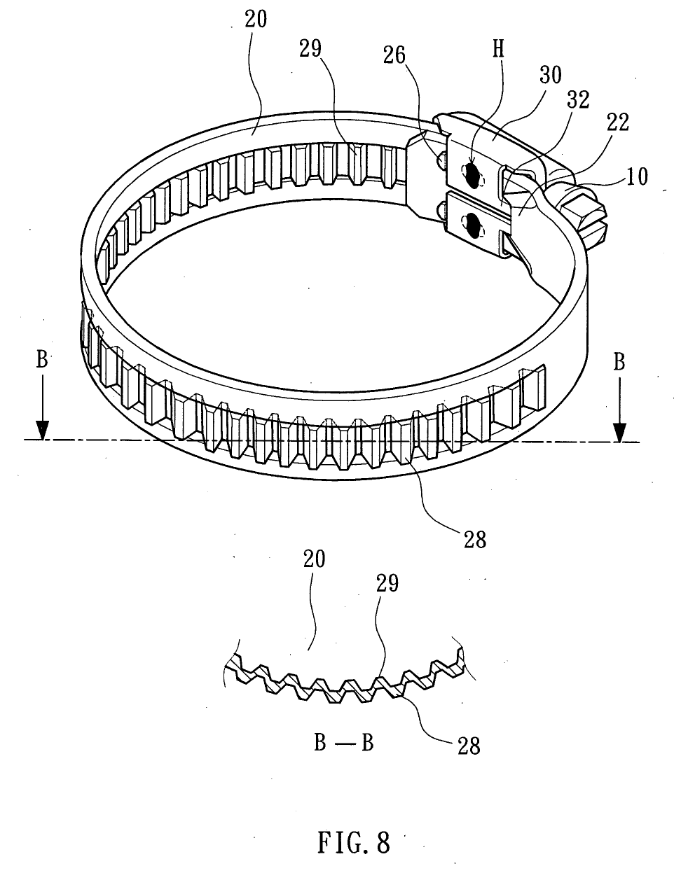

The hose clamp may be variously embodied. According to the embodiment shown in FIG. 4, there are three stop blocks 26 protruded from the bottom surface of the flat head 21 and transversely aligned in a line in front of the through hole 24. According to the embodiment shown in FIG. 5, a transverse stop rib 27 is provided at the flat head 21 to substitute for the aforesaid stop blocks 26. According to the embodiment shown in FIG. 6, the two mounting plates 31 of the screw holder 30 each have a welding flange 33 for welding to the flat bottom surface of the flat head 21 of the binding belt 20. According to the embodiment shown in FIG. 7, the binding belt 20 has a series of teeth 28 arranged around the outer (top) surface thereof for engagement with the screw 10. According to the embodiment shown in FIG. 8, the binding belt 20 has a first series of teeth 28 arranged around the outer (top) surface thereof for engagement with the screw 10 and a second series of teeth 29 arranged around the inner (bottom) surface thereof for engaging the peripheral wall of the hose to be affixed.

A prototype of hose clamp has been constructed with the features of FIGS. 2-8. The hose clamp functions smoothly to provide all the features discussed earlier.

Although particular embodiments of the invention have been described in detail for purposes of illustration various modifications and enhancements may be made without departing from the spirit and scope of the invention. Accordingly, the invention is not to be limited except as by the appended claims.

What the invention claimed is:

1. A hose clamp comprising:
a binding belt, said binding belt having a flat head, said flat head having a top surface and a bottom surface, a protruded portion adjacent to said flat head, a locating hole formed in said protruded portion, a through hole cut through said flat head, two welding flanges protruded from the bottom surface of said flat head at two opposite lateral sides of said through hole, and a plurality of stop blocks protruded from the bottom surface of said flat head in front of said through hole; and
a screw holder fastened to said flat head of said binding belt to hold a screw for joining the ends of said binding belt, said screw holder comprising two mounting plates respectively clamped on the bottom surface of said flat head and stopped between said stop blocks and said protruded portion and respectively welded to said welding flanges by spot welding, said mounting plates each having a positioning rod respectively engaged into said locating hole in said protruded portion.

2. The hose clamp as claimed in claim 1, wherein said stop blocks are connected to one another in a line, forming a transverse stop rib.

3. The hose clamp as claimed in claim 1, wherein said mounting plates of said screw holder each have a welding flange respectively welded to the flat bottom surface of said flat head by spot welding.
